(19) United States
(12) Patent Application Publication
(10) Pub. No.: US 2025/0147519 A1
(43) Pub. Date: May 8, 2025

(54) ROUTE PLANNING SYSTEM FOR AUTONOMOUS AGRICULTURAL WORK MACHINES

(71) Applicant: CLAAS KGaA mbH, Harsewinkel (DE)

(72) Inventors: Thijs Verploegen, Düsseldorf (DE); Stefan Peters, Münster (DE); Josef Fischer, Biberach (DE); Jan Carsten Wieckhorst, Uelzen Ortsteil Hanstedt 2 (DE); Jannik Redenius, Oldendorf (DE); Axel Schröder, Gütersloh (DE); Felix Hülsmann, Bielefeld (DE); Robin Monkenbusch, Rheda-Wiedenbrück (DE)

(73) Assignee: CLAAS KGaA mbH, Harsewinkel (DE)

(21) Appl. No.: 18/941,423

(22) Filed: Nov. 8, 2024

(30) Foreign Application Priority Data
Nov. 8, 2023 (DE) 10 2023 130 890.4

(51) Int. Cl. G05D 1/648; A01B 76/00; G05D 1/633; G05D 1/81; G05D 105/15; G05D 107/20

(52) U.S. Cl. CPC G05D 1/648; A01B 76/00; G05D 1/633; G05D 1/81; G05D 2105/15; G05D 2107/21

(57) ABSTRACT

A route planning system configured to create the route plan for an autonomous agricultural work machine and/or for a network of autonomous agricultural work machines. A given agricultural work machine may be operated in a semi-autonomous operating mode, in which a user is on board or resident in the agricultural work machine, or a fully autonomous operating mode, in which no user is assigned to the agricultural work machine. The generated route plan may be dynamically adapted depending on one or more events, with the dynamically adapted route plan being transmitted to the autonomous agricultural work machine. The user or an operator assigned to the given autonomous agricultural work machine may accept the adapted route plan for the given agricultural work machine.

### CROSS REFERENCE TO RELATED APPLICATIONS

This application claims priority under 35 U.S.C. § 119 to German Patent Application No. DE 10 2023 130 890.4 filed Nov. 8, 2023, the entire disclosure of which is hereby incorporated by reference herein. This application is related to US Application No. ______ (attorney-docket number 15191-24023A (P05789/8), which is incorporated by reference herein in its entirety.

### TECHNICAL FIELD

The present invention relates to a route planning system, which is configured to create the route plan for one or more autonomous agricultural work machines.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Route planning systems describe the cooperation of a plurality of agricultural work machines on a territory to be worked. By way of example, US Patent Application Publication No. 2007/0233374 A1, incorporated by reference herein in its entirety, discloses the cooperation of agricultural harvesting machines, such as combine harvesters, on a territory to be worked. The agricultural work machines may generate a route plan to be processed jointly, wherein the intention is to ensure that each area of the territory to be worked is worked by only one machine at a time.

US Patent Application Publication No. 2007/0135190 A1, incorporated by reference herein in its entirety, discloses a route plan of an agricultural work machine, which may comprise a combine harvester, may be dynamically adapted to changing positions of the combine harvester.

### BRIEF DESCRIPTION OF THE DRAWINGS

The present application is further described in the detailed description which follows, in reference to the noted drawings by way of non-limiting examples of exemplary embodiment, in which like reference numerals represent similar parts throughout the several views of the drawings, and wherein:

FIG. 1 illustrates schematic representation of the autonomous agricultural work machines involved in an agricultural process.

FIG. 2 illustrates an example schematic representation of the route planning system.

FIG. 3 illustrates an embodiment of the route planning system as shown in FIG. 2.

### DETAILED DESCRIPTION

As discussed in the background, route planning systems may generate or create route plans for a plurality of agricultural work machines on a territory to be worked. However, such route planning systems may have the disadvantage that they may only ever take into account work machines used simultaneously in a territory, and may also prevent the cooperating agricultural work machines from working the same area of the territory to be worked.

While the route planning systems disclosed in US Patent Application Publication No. 2007/0233374 A1 and US Patent Application Publication No. 2007/0135190 A1 are designed for manned agricultural work machines. Autonomously operating agricultural work machines, which in one expansion stage may operate entirely without a driver, are becoming increasingly prevalent. For such agricultural work machines, route planning systems are disclosed EP 3 970 463 A1 and DE 10 2020 109 013 A1, which generate route plans for autonomously operated agricultural work machines. The route plans may usually be generated in advance and then reach their limits if events occur during the execution of the pre-planned route plans in the field that force the given agricultural work machine to deviate from the pre-planned route.

Thus, in one or some embodiments, a route planning system is disclosed to avoid such disadvantages of the prior art and which may react flexibly to one or more changing conditions during the execution of a pre-planned route plan.

In one or some embodiments, the route planning system is configured to create the route plan of an autonomous agricultural work machine and/or of a network of autonomous agricultural work machines. The given or respective agricultural work machine may be operated in a semi-autonomous operating mode, in which an operator is on board or resident within a driver's cab of the agricultural work machine, or in a fully autonomous operating mode, in which no operator is assigned to the agricultural work machine. The route planning system may be automatically configured to create or generate the route plan and may be further automatically configured to dynamically adapt the route plan depending on one or more events. The route planning system may be automatically configured to transmit the dynamically adapted route plan to the autonomous agricultural work machine. In response to receipt of the dynamically adapted route plan, the operator or an operator assigned to the given or respective autonomous agricultural work machine may (or must) accept the adapted route plan for the given agricultural work machine. In this way, it may be ensured that the route planning system may react flexibly to changing conditions when executing a pre-planned route plan. In addition, in one or some embodiments, such a system may ensure that the modified route plan is only applied from a safety perspective if an authorized process participant approves it. Alternatively, responsive to receipt of the dynamically adapted route plan, the given or respective autonomous agricultural work machine may automatically accept the dynamically adapted route plan without any human intervention or approval.

In one or some embodiments, the operator is the driver of the agricultural work machine, with the operator having an electronic identification device which is assigned to the given autonomous agricultural work machine so that this mandatory authorization may be implemented in a technically simple manner.

In one or some embodiments, the one or more autonomous agricultural work machines are in a data exchange with a planning portal, an example of which is disclosed in US Patent Application No. ______ (attorney docket no. 15191-24023A (P05789/8), which is incorporated by reference herein in its entirety. The planning portal may be configured to monitor the work process of the one or more autonomous agricultural work machines and to describe an actual working situation which may form the input variable for an event-dependent dynamic adaptation of the route plan. The planning portal may be configured to propose a route plan, such as an optimization of the route plan, depending on the actual work situation. In one or some embodiments, the route plan, such as the optimization of the route plan, is ignored responsive to the user or operator rejecting the route plan. In this way, it may be ensured that the route plan to be created may be specifically adapted to the actual work situation and the acceptance may be performed by an authorized process participant, taking into account safety-relevant aspects.

In one or some embodiments, the acceptance of the optimization suggestion may be performed in a technically simple manner by an operator via an entry at a terminal, via a mobile APP application, or by the operator assigned to the driverless agricultural work machine.

In one or some embodiments, the route planning system may be further configured to generate a common event-dependent dynamically adapted route plan for the autonomous agricultural work machines and/or an individualized event-dependent dynamically adapted route plan for each agricultural work machine. The autonomous agricultural work machines may be further configured to exchange the event-dependent dynamically adapted route plan or plans between the autonomous agricultural work machines. In particular, this exchange may result in the given route plan being very specifically adapted to each of the autonomous agricultural work machines and exchanged between them. It is contemplated that one, some, or all of the autonomous agricultural work machines may be integrated into the process to create the dynamically adapted route plan itself.

In that the given common route plans and the given individualized route plans may also comprise routes, wherein each agricultural work machine may be assigned an individualized route in the given route plan, this may result in a simple control concept for all agricultural work machines integrated in the work process.

The autonomous agricultural work machines may operate on a territory to be worked. These autonomous agricultural work machines may each have a data transmission device, with the respective data transmission devices resident on the autonomous agricultural work machines being configured to enable data exchange between the autonomous agricultural work machines and/or the route planning system. This universal data exchange between the process participants may be performed in a technically simple manner.

In one or some embodiments, the autonomous agricultural work machine operated in a semi-autonomous operating mode may switch between fully autonomous operating mode and normal operation (e.g., manual driving) so that the autonomous agricultural work machine may perform work in a territory to be worked and may switch from autonomous operation to manual operation and vice versa depending on the work to be perform. This may have the effect that the operator of the agricultural work machine may control the agricultural work machine himself or herself at any time. This may have the advantageous when complicated terrain structures make autonomous operation risky or complicated.

In one or some embodiments, one or more events are contemplated to trigger event-dependent dynamic adaptation of the route plan. For example, an event that may trigger the event-dependent dynamic adaptation of the route plan may be the deviation of the autonomous agricultural work machine from a planned route due to circumventing an obstacle. Various obstacles are contemplated. For example, the obstacle may be a static and/or non-static obstacle. Such an embodiment has the effect that the dynamic adaptation of the route plan may ensure that areas of the territory to be worked are neither left unworked nor worked several times.

In this context, it may also be advantageous if the event that triggers the event-dependent dynamic adjustment of the route plan is the deviation of the current working status from the working status on which the route planning is based. In this way, it may be possible to react very flexibly if any one, any combination, or all of the following occurs: if more or fewer vehicles are available (e.g., present) than originally planned; if the agricultural work machines used in the same or a previous operation and the attachments assigned to them have different working widths than were taken into account in the planning (e.g., the working width of the attachment is different from that dictated or outlined in the route plan); or if agricultural work machines are added to or removed from the work process of a territory.

In this context, in one or some embodiments, it may also be advantageous if the event that triggers the event-dependent dynamic adjustment of the route plan is a combination of several events. In this way, it may be possible to react very flexibly to changes of various kinds in the territory to be processed.

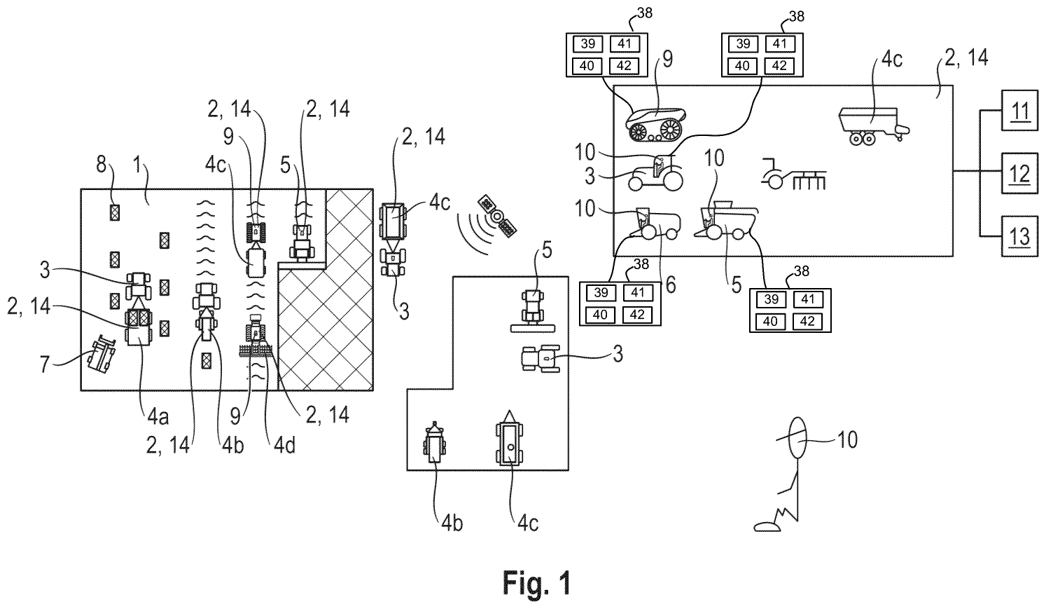

Referring to the figures, FIG. 1 illustrates an example of an agricultural application, wherein a plurality of agricultural work machines 2, to be described in more detail below, operate on the territory 1 to be worked. In the embodiment shown here, one or more agricultural work machines 2 may comprise a tractor 3 and may be coupled to a wide variety of attachments 4, such as a flatbed trailer 4a, square baler 4b and loader wagon 4c. By way of example, a combine harvester 5 and a forage harvester 6 are shown here as further examples of agricultural work machines 2. In addition, a so-called telescopic loader 7 is shown, which may regularly be used to load the harvested material bales 8 deposited on the territory 1 to be worked. Furthermore, the shown agricultural application may comprise agricultural work machines 2 designed as autonomous work units 9, wherein the autonomous work units 9 may be equipped with a wide variety of attachments 4, here for example with tillage machines 4d or loader wagons 4c.

The autonomous work units 9, which are known per se and therefore not described in detail here, may be designed in such a way that they are operated exclusively without a user 10 and therefore always work in a fully autonomous operating mode 11. Examples of autonomous work units 9 and the agricultural work machines 2 are disclosed in: US Patent Application Publication No. 2014/0324272 A1; US Patent Application Publication No. 2023/0350426 A1; US Patent Application Publication No. 2023/0350407 A1; US Patent Application Publication No. 2023/0350423 A1; US Patent Application Publication No. 2023/0350409 A1; US Patent Application Publication No. 2023/0345856 A1; or US Patent Application Publication No. 2024/0065155 A1, each of which are incorporated by reference herein in their entirety.

The other agricultural work machines 2 shown in FIG. 1, such as the tractor 3, the combine harvester 5, the forage harvester 6 and the telescopic loader 7, may be operated by a user 10 in normal mode 12. However, in a manner to be described in more detail, these agricultural work machines 2 may also be equipped in such a way that the given agricultural work machine 2 may be operated in a semi-autonomous operating mode 13, wherein when activating the semi-autonomous operating mode 13, the operator 29 of the given agricultural work machine 2, may still be on the given agricultural work machine 2, but may no longer be involved in the control and regulation process of the given agricultural work machine 2.

In the following, the autonomous work units 9 that may be operated in the fully autonomous operating mode 11 and the agricultural work machines 2 that may be operated in the semi-autonomous operating mode 13 are collectively referred to as autonomous agricultural work machines 14.

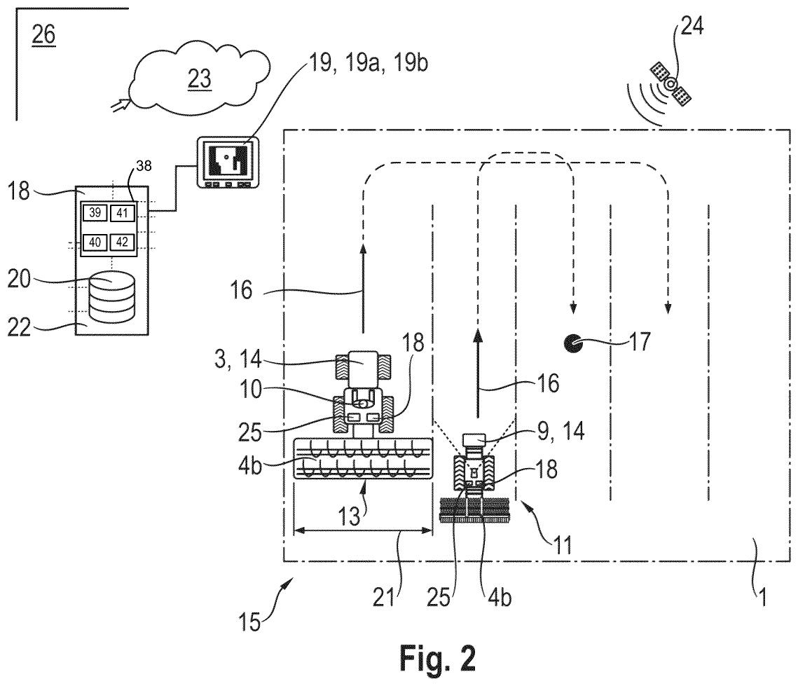

FIG. 2 describes in more detail using the example of a tractor-attachment combination, such as a tractor 3 combined with tillage machine 4b, and a combination of autonomous working unit 9 and attachment 4 assigned thereto, also designed as a tillage machine 4b. In order to better explain aspects of the invention, the same attachment 4 is selected for the tractor 3 and the autonomous working unit 9. According to one or some embodiments, the tractor 3 and the autonomous working unit 9 each form an autonomous agricultural work machine 14, which may either be used individually on a territory 1 to be worked or, as shown, in a network 15 of autonomous agricultural work machines 14 on the territory 1 to be worked. As previously described, the tractor 3 may be operated in a semi-autonomous operating mode 13 due to the fact that it has a user 4 (e.g., an operator of the respective agricultural work machine 2), while the autonomous work unit 9 may be operated exclusively in an autonomous operating mode 11.

Each of the autonomous agricultural work machines 14 may work the territory 1 in a known manner along routes 16. In the case of single-machine operation, the routes 16 may be laid out in such a way that the single autonomous agricultural work machine 14 processes the territory 1 completely, and double processing of the territory 1 is sought to be avoided. If the autonomous agricultural work machines 14 are used in a network 15 on the territory 1, it may also be ensured that a collision of the agricultural work machines 14 with each other is avoided. First of all, this requires that the agricultural work machines 14 know the given positions of the other agricultural work machines 14. This may be performed, for example, based on communication of the current location of the agricultural work machines 14 (based on a GPS receiver being resident on the agricultural work machines 14) amongst the different agricultural work machines 14. In addition, the routes 16 of all autonomous agricultural work machines 14 used on a territory 1 may be such that they avoid obstacles 17, wherein obstacles may be either stationary obstacles such as power line poles or trees, or mobile obstacles such as animals, people or vehicles.

Central data processing device 18 may perform in a planning step 20 to pre-plan a route plan 19 for working the territory 1. In this planning step 20, inter alia, the dimensions of the territory 1 to be worked and the working width 21 of the given attachment 4 may be taken into account. The route planning systems may also be such that they generate either an individualized route plan 19a for the single autonomous agricultural work machine 14, or each autonomous agricultural work machine 14 of a network 15, or a common route plan 19b for all autonomous agricultural work machines 14 of a network 15. The data processing device 18 generating the given route plan 19 may be assigned to a central server 22, a cloud 23 or one of the autonomous agricultural work machines 14. Furthermore, the route plan 19 may be transmitted to the autonomous agricultural work machines 14 based on GPS 24. To make this possible, transmitting and receiving units 25 may be assigned to the autonomous agricultural work machines 14 so that each of the autonomous agricultural work machines 14 may receive and transmit data. In the following, at least the data processing device 18, the route plan or plans 19, 19a, 19b generated thereby, the GPS-based data transmission 24 and the transmitting and receiving units 25 may be collectively referred to as the route planning system 26, which is described in more detail below.

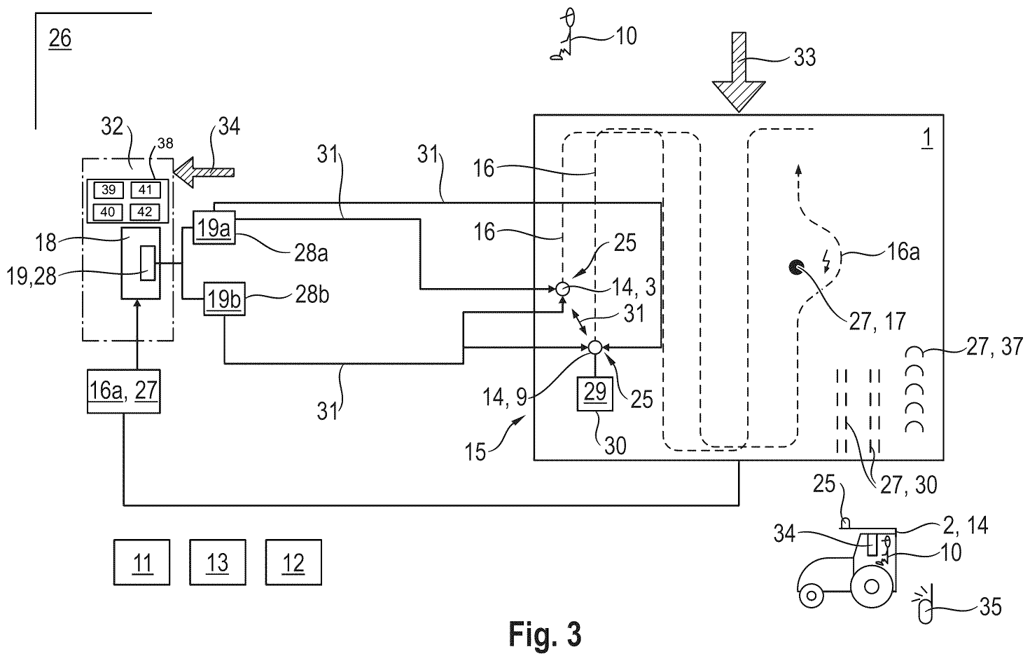

FIG. 3 illustrates an example of the route planning system 26. The route plan 19 generated by the data processing device 18 may either be transmitted individually as an individualized route plan 19a to each autonomous agricultural work machine 14 used on the territory 1, or may be transmitted as a common route plan 19b to all autonomous agricultural work machines 14 used in the network 15. Each route plan 19, 19a, 19b may define a route 16 for each autonomous agricultural work machine 14, wherein the routes 16 may be coordinated with one another in such a way that the territory 1 is processed by the autonomously operating agricultural work machines 14 with little to no overlap. During the execution of this predefined route plan 19, 19a, 19b, events 27 to be described in greater detail below such as the stationary or mobile obstacles 17 already mentioned, may occur which trigger a change 16a in the route 16. If the originally defined route plan 19, 19a, 19b were now further processed, collisions between the autonomously operating agricultural work machines 14 may occur on the one hand, or the territory 1 cannot be worked at all or may be worked several times, at least in the area of the change 16a of the route 16. This is where one aspect of the invention is applied, in that the created route plan 19, 19a, 19b may be dynamically adapted in an event-dependent manner depending on an event 27 that occurs. In a manner to be described in more detail, the event 27 and/or the change 16a to the given route 16 resulting therefrom may be automatically transmitted to the data processing device 18, and a dynamically adapted route plan 28 may then be automatically created in the data processing device 18, wherein the dynamically adapted route plan 28 may be an individualized route plan 28a or a common route plan 28b depending on the number of autonomous agricultural work machines 14 used in the territory 1. The given dynamically adapted route plan 28, 28a, 28b may then be automatically transmitted based on GPS 24 (e.g., GPS receiver) to the autonomous agricultural work machines 14, wherein the given transmitted route plan 28, 28a, 28b does not automatically replace the existing route plans 19, 19a, 19b, but the event-dependent dynamically adapted route plan 28a, 28b must be accepted either by the user 10 or by an operator 29 assigned to the given autonomous agricultural work machine 14, and only then may the active route plan 19 be overwritten by the event-dependent dynamically adapted route plan 28. The operator 29 may always be used when the autonomously driving agricultural work machine 14 is designed as a tractor 3 with operator 29, for example, as already described. Due to the fact that the described autonomous work unit 9 does not have a user 10 directly assigned to it, it is assigned a so-called operator 29, to be described in more detail, which is either a human user 10 arranged at a remote location or, in the simplest case, an electronic identification device 30 instead of a human user 10, which makes the decision to accept or reject the event-dependent dynamically adapted route plan 28. Alternatively, in the event that an operator (whether at the agricultural work machine 14 or at a remote location) is not present, the dynamically adapted route plan 28a, 28b may be automatically accepted (without human intervention) by any autonomous machines, such as by the autonomous work units 9 or the autonomous agricultural work machines 14.

Technically, the event-dependent dynamic adaptation of the route plan 28 may be implemented in such a way that the one or more autonomous agricultural work machines 14 are in data exchange 31 with a planning portal 32. The planning portal 32 may be configured to automatically monitor the work process of the one or more autonomous agricultural work machines 14 and to describe an actual work situation 33 which may automatically form the input variable for an event-dependent dynamic adaptation of the route plan 28. Responsive to automatically identifying a need to dynamically adapt the route plan 28 (e.g., based on monitoring the work process, based on describing the actual work situation 33, etc.), the planning portal 32 may be configured to automatically propose or generate an optimization 28 of the route plan 19 depending on the actual work situation 33. In one or some embodiments, the optimization proposal 28 may be ignored responsive to the user 10 or the operator 29 rejecting the optimization proposal 28 (e.g., whereby the optimization proposal 28 may be automatically presented to user 10 or the operator 29 to include the event-dependent dynamically adapted route plan 28; responsive to the automatic presentation, the user 10 or the operator 29 may provide input to reject the optimization proposal 28). Conversely, the user 10 or the operator 29 may accept the optimization proposal 28. In one form, acceptance of the optimization proposal 28 by a user 10 may occur by the user 10 inputting at a terminal 34 assigned to the given agricultural work machine 2, via a mobile app 35 or, in the case of the autonomous work unit 9, by the described operator 29.

As previously described, the route planning system 26 may be further configured to generate a common event-dependent dynamically adapted route plan 28b for the autonomous agricultural work machines 14 and/or an individualized event-dependent dynamically adapted route plan 28a for each agricultural work machine 14, wherein the autonomous agricultural work machines 14 may be further configured to exchange the event-dependent dynamically adapted route plan or plans 28, 28a, 28b between the autonomous agricultural work machines 14. This may have the effect that the route plan 28, 28a, 28b generated, for example, in the remote planning portal 32 would only have to be transmitted to one autonomous agricultural work machine 14 and from there would only have to be exchanged over short data transmission distances between the autonomously operating agricultural work machines 14. In this way, data transmission problems that may occur when overcoming long distances would be reduced. Alternatively, the remote planning portal 32 may transmit the route plan 28, 28a, 28b directly to one, some, or each of the autonomously operating agricultural work machines 14.

In that the common route plans 28b and the individualized route plans 28a each may comprise routes 16 and each autonomous agricultural work machine 14 may be assigned an individualized route 16 in the given route plan 28a, 28b, each of the autonomous agricultural work machines 14 may operate safely in the territory 1 to be worked. As previously described, the autonomous agricultural work machines 14 active on the territory 1 to be worked may each have a data transmission device 25, wherein the respective data transmission device 25 may be configured to enable data exchange 31 between the autonomous agricultural work machines 14 and the route planning system 26. In this way, the autonomous agricultural work machines 14 may communicate flexibly with each other and with the planning portal 32, for example. In this way, it may also be possible for the dynamically adapted route plan 28, 28a, 28b to be generated directly on an autonomous agricultural work machine 14 integrated into the work process. This may have the advantage that the given agricultural work machine 14 may itself determine the actual working situation 33 or actual working state via one or more suitable sensors. In this regard, the dynamically adapted route plan 28, 28a, 28b may be generated in various electronic devices within the system, such as at one or both of the route planning system 26 or the autonomous agricultural work machines 14.

In the event that the autonomous agricultural work machine 14, such as the tractor 3, is operated in the semi-autonomous operating mode 13, the autonomous agricultural work machine 14 may switch between a fully autonomous operating mode 11 and manual driving, the normal mode 12, wherein the autonomous agricultural work machine 14 may switch from an autonomous mode to a manual mode and vice versa in a territory 1 to be worked depending on the work to be performed.

As previously described, the dynamically adapted route plan 28, 28a, 28b may be adapted depending on an occurring event 27. A most frequently occurring event 27 may be the deviation of the autonomous agricultural work machine 14 from a planned route 16 due to circumventing an obstacle 17, whereby the obstacle 17 may be a static and/or non-static obstacle 17.

Another frequently occurring event 27 may be the deviation of the current processing status from the processing status on which the route plan 19 is based. This event 27 may occurs if, for example, more or fewer agricultural work machines 14 are available than planned, the agricultural work machines 14 are equipped with attachments 4 whose working width 21 deviates from the working width 21 on which the route planning was originally based, or agricultural work machines 14 leave a network 15 due to defects, or additional agricultural work machines 14 are added (e.g., monitoring operations of the respective autonomous agricultural work machines in order to determine whether the respective autonomous agricultural work machines are joining in performing the route plan or leaving the route plan). Other contemplated events 27 may also be lanes 36 in the territory 1 to be worked, which are to be reused by the autonomous agricultural work machines 14 active in the territory 1 to be worked. In this case, the originally planned route plan 19, 19a, 19b may then be dynamically adapted in such a way that the new route plan 28, 28a, 28b adapts the given routes in such a way that the autonomous agricultural work machines 14 may use the existing lanes 36.

A further event 27 may be, for example, the position of a harvested material swath 37 on the territory 1 to be worked, wherein the dynamically adapted route plan 28, 28a, 28b may then be made available to an autonomous agricultural work machine 14 designed as a forage harvester 6.

Depending on the work to be performed by the autonomous agricultural work machines 14 on the given territory 1, the event 27 may also be a combination of a wide variety of events 27.

As discussed above, various devices may operate automatically or at least partly automatically. Merely as examples, agricultural production machines 2, tractors 3, combine harvesters 5, forage harvesters 6, autonomous working unit 9, data processing device 18, central server 22, cloud 23, data transmission device 25, route planning system 26, planning portal 32, terminal 34, and mobile app 35 may operate at least partly automatically, as discussed herein. In this regard, in one or some embodiments, these devices may include control unit(s) 38. Control unit(s) 38 may include at least one processor 39, at least one memory 40, at least one communication interface 41, and at least one display 42 (such as a touchscreen). The at least one processor 39 and at least one memory 40 may be in communication (e.g., wired and/or wirelessly) with one another. In one or some embodiments, the processor 39 may comprise a microprocessor, controller, PLA, or the like. Similarly, the memory 40 may comprise any type of storage device (e.g., any type of memory). Though the processor 39 and the memory 40 are depicted as separate elements, they may be part of a single machine, which includes a microprocessor (or other type of controller) and a memory. Alternatively, the processor 39 may rely on the memory 40 for all of its memory needs. Still alternatively, the processor 39 may rely on a database for some or all of its memory needs. The memory 40 may comprise a tangible computer-readable medium that include software that, when executed by the processor 39 is configured to perform any one, any combination, or all of the functionality described herein, such as the functionality of the route planning (and updating or dynamically adapting the route plan(s)), the at least partly automatic (or fully automatic) operation of agricultural work machines or autonomous agricultural work machines or other automatic operation devices discussed herein. Further, the communication interface 41 may be configured to communicate (e.g., wired and/or wirelessly) with one or more external electronic devices. For example, any one, any combination, or all of the following may be configured to communicate with another: agricultural production machines 2; tractors 3; combine harvesters 5; forage harvesters 6; autonomous working unit 9; data processing device 18; central server 22; cloud 23; data transmission device 25; route planning system 26; planning portal 32; terminal 34; or mobile app 35.

The processor 39 and the memory 40 are merely one example of a computational configuration for the electronic devices discussed herein. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

List of Reference Numbers

| | |
|---|---|
| 1 | Territory |
| 2 | Agricultural production machine |
| 3 | Tractor |
| 4 | Attachment |
| 4a | Flatbed trailer |
| 4b | Square baler |
| 4c | Loader wagon |
| 4d | Tillage machine |
| 5 | Combine harvester |
| 6 | Forage harvester |
| 7 | Telescopic loader |
| 8 | Harvested material bales |
| 9 | Autonomous working unit |
| 10 | Operator |
| 11 | Fully autonomous operating mode |
| 12 | Normal mode |
| 13 | Partially autonomous operating mode |
| 14 | Autonomous agricultural production machine |
| 15 | Bonding |
| 16 | Travel route |
| 17 | Obstacle |
| 18 | Data processing device |
| 19 | Route plan |
| 19a | Individualized route plan |
| 19b | Common route plan |
| 20 | Planning step |
| 21 | Working width |
| 22 | Central server |
| 23 | Cloud |
| 24 | GPS |
| 25 | Data transmission device |
| 26 | Route planning system |
| 27 | Event |
| 28 | Route plan |
| 28a | Individualized route plan |
| 28b | Common route plan |
| 29 | Operator |
| 30 | Identification device |
| 31 | Data exchange |
| 32 | Planning portal |
| 33 | Actual work situation |
| 34 | Terminal |
| 35 | Mobile app |
| 36 | Lane |
| 37 | Harvested material swath |
| 38 | Control unit |
| 39 | Processor |
| 40 | Memory |
| 41 | Communication interface |
| 42 | Display |

1. A route planning system comprising:
at least one communication interface; and
at least one processor in communication with the at least one communication interface, the at least one processor configured to:
create a route plan for one or both of an autonomous agricultural work machine or for a network of the autonomous agricultural work machines, wherein a respective autonomous agricultural work machine is operated in a semi-autonomous operating mode in which a user is on board the respective autonomous agricultural work machine or a fully autonomous operating mode in which no user is assigned to the respective autonomous agricultural work machine;
responsive to identifying at least one event:
dynamically adapt the route plan depending on the at least one event to generate a dynamically adapted route plan; and
transmit, via the at least one communication interface, the dynamically adapted route plan for receipt by the respective autonomous agricultural work machine in order for the respective autonomous agricultural work machine to operate at least partly automatically using the dynamically adapted route plan.

2. The route planning system of claim 1, wherein the at least one processor is configured to transmit the dynamically adapted route plan to a person assigned to the respective autonomous agricultural work machine in order to request the person to accept the dynamically adapted route plan for the respective agricultural work machine; and
wherein, responsive to receipt of approval for the dynamically adapted route plan from the person assigned to the respective autonomous agricultural work machine, the at least one processor is configured to transmit the dynamically adapted route plan to the respective autonomous agricultural work machine in order for the respective autonomous agricultural work machine to use the dynamically adapted route plan to at least partly automatically operate the respective autonomous agricultural work machine.

3. The route planning system of claim 2, wherein the person comprises at least one of a driver of the respective autonomous agricultural work machine or an operator of an electronic identification device assigned to the respective autonomous agricultural work machine.

4. The route planning system of claim 2, wherein one or more autonomous agricultural work machines are in data exchange with a planning portal;
wherein the planning portal is configured to monitor one or more work processes of the one or more autonomous agricultural work machines and to describe an actual work situation;
wherein the planning portal is configured to input the actual work situation as an input variable for an event-dependent dynamic adaptation of the route plan; and
wherein the planning portal is configured to automatically propose an optimization of the route plan depending on the actual work situation.

5. The route planning system of claim 4, wherein the planning portal is further configured to:
automatically transmit the optimization of the route plan to the person for at least one of acceptance or rejection of the optimization of the route plan;
receive a response from the person;
responsive to the response indicating the acceptance, automatically implement the optimization of the route plan; and
responsive to the response indicating the rejection, automatically ignore the optimization of the route plan.

6. The route planning system of claim 5, wherein the planning portal is configured to receive the response from the person via one of: a terminal remote from the respective autonomous agricultural work machine through which a remote operator inputs the response; a mobile app through which the remote operator inputs the response; or the respective autonomous agricultural work machine through which an operator of the respective autonomous agricultural work machine through inputs the response.

7. The route planning system of claim 1, wherein the at least one processor is further configured to:
generate one or both of: a common event-dependent dynamically adapted route plan for plurality of autonomous agricultural work machines or an individualized event-dependent dynamically adapted route plan for each of the plurality of autonomous agricultural work machines.

8. The route planning system of claim 7, wherein at least some of the plurality of autonomous agricultural work machines are configured to exchange the individualized event-dependent dynamically adapted route plan or plans amongst or between the plurality of autonomous agricultural work machines.

9. The route planning system of claim 8, wherein the common event-dependent dynamically adapted route plan and the individualized event-dependent dynamically adapted route plan comprise travel routes; and
wherein each of the plurality of autonomous agricultural work machines is assigned an individualized route for at least one of the common event-dependent dynamically adapted route plan or the individualized event-dependent dynamically adapted route plan.

10. The route planning system of claim 7, wherein each of the plurality of autonomous agricultural work machines is active on a territory to be worked;
wherein each of the plurality of autonomous agricultural work machines has a data transmission device; and
wherein the data transmission devices are configured to enable a data exchange between the plurality of autonomous agricultural work machines and the route planning system.

11. The route planning system of claim 1, wherein the respective autonomous agricultural work machine is configured to, when operating in a semi-autonomous operating mode, switch between a fully autonomous operating mode and normal operation enabling manual driving; and
wherein the respective autonomous agricultural work machine is configured to perform work in a territory to be worked and to switch from the fully autonomous operating mode to the manual driving and vice versa depending on the work to be performed.

12. The route planning system of claim 1, wherein the at least one processor is resident on the respective autonomous agricultural work machine so that the dynamically adapted route plan is generated on the respective autonomous agricultural work machine.

13. The route planning system of claim 1, wherein the at least one event that triggers the at least one processor to automatically dynamically adapt the route plan is a deviation of the respective autonomous agricultural work machine from a planned route due to circumventing an obstacle.

14. The route planning system of claim 13, wherein the at least one processor is configured to identify the deviation by comparing a current location of the respective autonomous agricultural work machine with the planned route; and
wherein, responsive to the at least one processor identifying the deviation, the at least one processor is configured to dynamically adapt the route plan depending on the current location of the respective autonomous agricultural work machine.

15. The route planning system of claim 14, wherein the obstacle comprises one or both of a static obstacle or a non-static obstacle.

16. The route planning system of claim 1, wherein the at least one event which triggers the event-dependent dynamic adaptation of the route plan comprises a deviation of a current working status of the respective autonomous agricultural work machine from a working status on which the route planning is based; and
wherein the at least one processor is configured to identify the deviation of the current working status of the respective autonomous agricultural work machine from the working status on which the route planning is based by monitoring the current working status of the respective autonomous agricultural work machine and comparing the current working status of the respective autonomous agricultural work machine with the working status on which the route planning.

17. The route planning system of claim 1, wherein the at least one event which triggers the event-dependent dynamic adaptation of the route plan comprises presence of more or fewer autonomous agricultural work machines than planned in the route plan; and
wherein the at least one processor is configured to identify the presence of more or fewer autonomous agricultural work machines than planned in the route plan by monitoring the presence of respective autonomous agricultural work machines performing the route plan to determine the presence of more or fewer autonomous agricultural work machines than planned in the route plan.

18. The route planning system of claim 1, wherein the at least one event which triggers the event-dependent dynamic adaptation of the route plan comprises the respective autonomous agricultural work machine being equipped with at least one attachment whose working width deviates from the working width as dictated by the route plan; and
wherein the at least one processor is configured to identify the respective autonomous agricultural work machine being equipped with at least one attachment whose working width deviates from the working width as dictated by the route plan by:
monitoring the at least one attachment who is to be connected or is connected to the respective autonomous agricultural work machine;
determining the working width for the at least one attachment; and
comparing the working width for the at least one attachment with the working width as dictated by the route plan.

19. The route planning system of claim 1, wherein the at least one event which triggers the event-dependent dynamic adaptation of the route plan comprises identifying the respective autonomous agricultural work machines joining in performing the route plan or leaving the route plan; and
wherein the at least one processor is configured to identify the respective autonomous agricultural work machines joining in performing the route plan or leaving the route plan by monitoring operations of the respective autonomous agricultural work machines in order to determine whether the respective autonomous agricultural work machines are joining in performing the route plan or leaving the route plan.

20. The route planning system of claim 1, wherein the at least one event which triggers the event-dependent dynamic adaptation of the route plan comprises a combination of events.
